(19) United States
(12) Patent Application Publication
(10) Pub. No.: US 2024/0176840 A1
(43) Pub. Date: May 30, 2024

(54) PREDICTING A MEANINGFUL EVENT BASED ON USER INTERACTION DATA FOR A WEBPAGE

(71) Applicant: MICROSOFT TECHNOLOGY LICENSING, LLC, Redmond, WA (US)

(72) Inventors: Sarvesh NAGPAL, Issaquah, WA (US); Mustafa Leithy Mohamed Leithy ALI, Cairo (EG); Toby Hamilton WALKER, Newton, MA (US); Sam Lucas MARTIN, Redmond, WA (US); Priyanka Dilip VED, Bellevue, WA (US); Michel Naim Naguib GERGUIS, Cairo (EG)

(21) Appl. No.: 18/070,356

(22) Filed: Nov. 28, 2022

(51) Int. Cl. G06F 16/958; H04L 67/50

(52) U.S. Cl. CPC G06F 16/958; H04L 67/535

(57) ABSTRACT

Disclosed herein is a system for capturing user interactions associated with a webpage or an application, and analyzing the captured user interactions to determine meaningful information. The meaningful information is provided to a provider of the webpage or to the application. The meaningful information provides valuable insight into a state of the user experience for a user interacting with the webpage or the application. Moreover, the meaningful information can include a prediction of an action the user interacting with the webpage or the application is likely to implement in the future based on the state of the user experience. The meaningful information is provided in real-time, or near real-time. Consequently, the provider of the webpage or the application can act on the meaningful information before the user implements the action.

### BACKGROUND

Capturing user interactions while various users are browsing a webpage can be valuable to a provider of the webpage. The provider can analyze the captured user interactions to improve the user experience offered by the webpage. Improving the user experience can include modifying the content of the webpage. For example, the provider can improve the user experience by modifying the layout and/or the positioning of graphical user interface elements, by adjusting the size of the graphical user interface elements, and so forth.

Conventional mechanisms configured to capture and report user interactions associated with a webpage are lacking with regard to quality and timeliness. More specifically, the captured user interactions are typically reported via a dataset that fails to include meaningful information representing a state of the user experience and/or actions a user may take based on the state of the user experience. Furthermore, these conventional mechanisms typically package the dataset for reporting purposes at a later time (e.g., thirty minutes, one hour) after the user has already left the webpage. This magnitude of delay in reporting the dataset causes the dataset to be stale, which can be detrimental to a provider of the webpage in various contexts. For example, by the time the provider of the webpage is able to analyze the stale dataset in an attempt to determine an issue with the user experience, the user has already stopped interacting with the webpage (e.g., the user has left, or closed, the webpage). Consequently, the provider of the webpage has no reasonable opportunity to take meaningful action to manage and/or improve the user experience and, for this reason, utilization rates of these conventional mechanisms configured to capture and report user interactions are low.

It is with respect to these and other considerations that the disclosure made herein is presented.

### SUMMARY

The techniques disclosed herein implement a system that captures user interactions associated with a webpage and that analyzes the captured user interactions to determine meaningful information. The meaningful information is provided to a provider of the webpage. As described herein, the meaningful information provides valuable insight into a state of the user experience for a user interacting with the webpage. Moreover, the meaningful information can include a prediction of an action the user interacting with the webpage is likely to implement in the future based on the state of the user experience.

The system provides the meaningful information to the provider of the webpage in real-time, or near real-time. Consequently, the provider of the webpage can act on the meaningful information before the user takes the action. Stated alternatively, the techniques described herein enable webpage operators to overcome the aforementioned delay between observing what users are doing on webpages and being able to take meaningful action in response to what the users are doing on the webpages. For instance, if the action is determined to be an abandonment of the user experience due to user frustration with a function of the webpage, the provider of the webpage can display a pop-up graphical user interface element that displays information intended to help the user locate and/or understand the function of the webpage. In this way, the system described herein helps the provider of the webpage with user engagement and, in association, achieve goals associated with the webpage. That is, the user is more likely to stay engaged with the content of the webpage rather than close the webpage due to the frustration with the experience offered by the webpage.

A webpage (e.g., “www.examplesite.com/page1”) is typically part of a broader website (e.g., “www.examplesite.com”) intended to provide content and/or a service to users (may be referred to herein as consumers). For instance, the service can relate to article consumption (e.g., world news articles, sports news articles, stock market news articles, scientific articles), ecommerce and/or transaction processing, electronic mail, social media, and so forth. The provider of the webpage is typically the provider of the website, and may alternatively be referred to as a developer or operator of the webpage.

The manner in which a webpage, or alternatively a website, renders content for display and interaction contributes to the experience for the user (referred to herein as the “user experience”). Furthermore, a provider of the webpage may define strategic goals for the webpage that contribute to the user experience. In the context of ecommerce, example goals can include getting a user to sign up for a newsletter, complete a purchase of a product found on the website, etc. Accordingly, the state of the user experience, as described herein, can represent the history of the user interactions with the website and the state in which the content is rendered for display and interaction. Moreover, the state of the user experience can represent whether the user interactions align with strategic goals established for the webpage by the provider of the webpage.

The system described herein is configured to receive interaction data associated with a webpage. The interaction data includes user interactions with content of the webpage and/or with a browser window within which the content of the webpage is rendered for display. The content of the webpage can include various graphical user interface elements for title text, body text, images, drawings, and so forth. A graphical user interface element can be selectable (e.g., a button configured to be “clicked”) or not selectable. The browser window can include an address bar, a tab for the webpage, and/or other functionality related to interacting with the webpage (e.g., scrolling controls, an exit button to close the webpage, a refresh button to reload the webpage, a button to add the webpage to a favorites list).

In various examples described herein, an individual user interaction includes movement of a cursor (e.g., under control of a mouse or touch) from a first position on the webpage and/or the browser window to a second position on the webpage and/or the browser window. Accordingly, the interaction data can include coordinates (e.g., x/y coordinates) that represent a current position of the cursor on a display screen. An individual user interaction can additionally or alternatively include a scrolling action that changes the content of the webpage that is currently rendered in the browser window. Accordingly, the interaction data can identify portions of the webpage that are visible to a user at a given time and/or how often a user is scrolling to view new portions of the webpage content. An individual user interaction can additionally or alternatively include selections of graphical user interface elements rendered via the webpage. Accordingly, the interaction data includes an identification of the graphical user interface that the user has selected. Additionally, the interaction data can include information the user has entered on the webpage (e.g., text typed in to complete a form on the webpage).

The system applies a machine learning model to the interaction data. The machine learning model is configured to predict an occurrence of an event. The system trains the machine learning model to predict occurrences of the event using labeled interaction data that is known to precede the event. For instance, the labeled interaction data can include billions or even trillions of unstructured user interactions.

An event represents, or provides insight into, the state of the user experience. Accordingly, there are many different types of events, the predictions of which can be meaningful to providers of webpages. For example, some events can indicate, to the provider of the webpage, that a user is frustrated with the manner in which the webpage renders its content for display and interaction (e.g., the layout makes it difficult to find a particular graphical user interface element), and thus, the user is about to leave the webpage. In another example, some events can indicate, to the provider of the webpage, that a user is about to implement an action that has a negative effect on strategic goals defined for the webpage as in, for example, the user leaving the website. In yet another example, some events can indicate, to the provider of the webpage, that a user is pleased with the manner in which the webpage renders its content for display and interaction. Accordingly, a prediction of an occurrence of an event by the machine learning model can provide meaningful information about the quality of the experience for a particular user.

The meaningful information can be positive such that the quality of the experience is meeting expectations for the user and/or for the provider of the webpage. For example, a specific type of event can signal that an ecommerce item is predicted to be added to the online shopping cart (e.g., an “Add to Cart” event) and/or predicted to be purchased (e.g., a “Purchase Detection” event). These types of events are generally a positive event for an ecommerce webpage. Accordingly, the provider of the ecommerce webpage may act on the predicted occurrence of these events to recommend additional ecommerce items for the user to add to the online shopping cart (e.g., upsell the currently added item to a higher quality version, introduce a new item related to the one already added to the online shopping cart). In another example, a specific type of event can signal that an article presented for consumption on a webpage is predicted to be fully consumed (e.g., an “Article Fully Consumed” event). This type of event is also generally a positive event for an article webpage. Accordingly, the provider of the article webpage may act on the predicted occurrence of this event to fetch and present a link to another related article before the user leaves the webpage and/or the website.

In contrast, the meaningful information can be negative such that the quality of the experience is not meeting expectations for the user and/or for the provider of the webpage. For example, a specific type of event can signal that an online shopping cart that already contains an item is going to be abandoned (e.g., a “Cart Abandoned” event). This type of event is generally a negative event for an ecommerce webpage. Accordingly, the provider of the ecommerce webpage may act on the predicted occurrence of this event by offering a discount (e.g., a 5% discount) for the item in case the (high) price of the item is the reason the user is abandoning the online shopping cart. In another example, a type of event can signal that a user needs help with a particular function offered by the webpage (e.g., a “User Frustrated” event). This type of event is also generally a negative event for any type of webpage. Accordingly, the provider of the webpage may act on the predicted occurrence of this event by introducing, moving, and/or increasing the size of a support button for the function so the user can easily notice and select the support button.

The aforementioned examples are just a few of many different types of events that can provide meaningful insights to providers of different types of webpages and websites. Consequently, the providers of the webpages are equipped with actionable information useable to improve the user experience. In various examples, a provider of a webpage can provide input that defines a type of event that is meaningful, as this may vary from one provider to the next.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates an example environment in which a system is configured to predict an occurrence of an event based on interaction data associated with a webpage and to provide the prediction of the occurrence of the event to a provider of the webpage.

FIG. 1B illustrates an example environment in which a system is configured to predict an occurrence of an event based on interaction data associated with an application and to provide the prediction of the occurrence of the event to the application.

FIG. 2 illustrates the example environment of FIG. 1A in which the provider of the webpage can implement an action in response to receiving the prediction of the occurrence of the event.

FIG. 3 illustrates a diagram that captures a training stage and an application stage for a machine learning model.

FIG. 4 illustrates a diagram that captures how different machine learning models can be trained to predict events for different types of webpages or applications.

FIG. 5 is a flow diagram of an example method for predicting an occurrence of an event based on interaction data associated with a webpage or an application.

FIG. 6 is a computer architecture diagram illustrating an illustrative computer hardware and software architecture for a computing system capable of implementing aspects of the techniques and technologies presented herein.

### DETAILED DESCRIPTION

The following Detailed Description discloses techniques and technologies for capturing user interactions associated with a webpage or an application, and analyzing the captured user interactions to determine meaningful information. The meaningful information is provided to a provider of the webpage or to an application. The meaningful information provides valuable insight into a state of the user experience for a user interacting with the webpage or the application. Moreover, the meaningful information can include a prediction of an action the user interacting with the webpage or the application is likely to implement in the future based on the state of the user experience. The meaningful information is provided in real-time, or near real-time. Consequently, the provider of the webpage or the application can act on the meaningful information before the user implements the action.

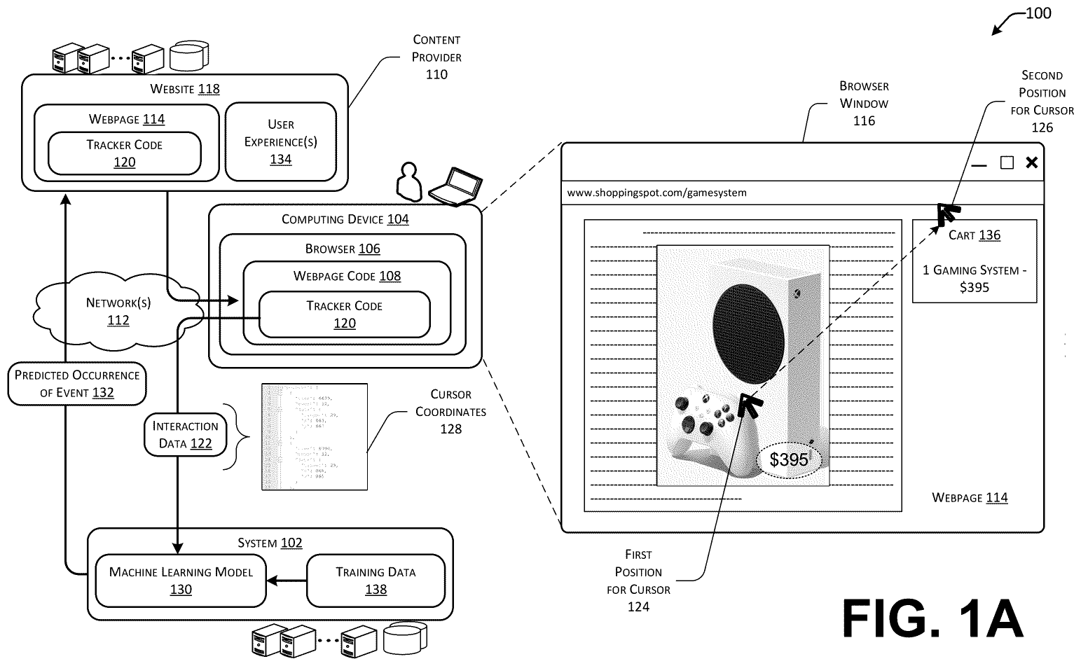

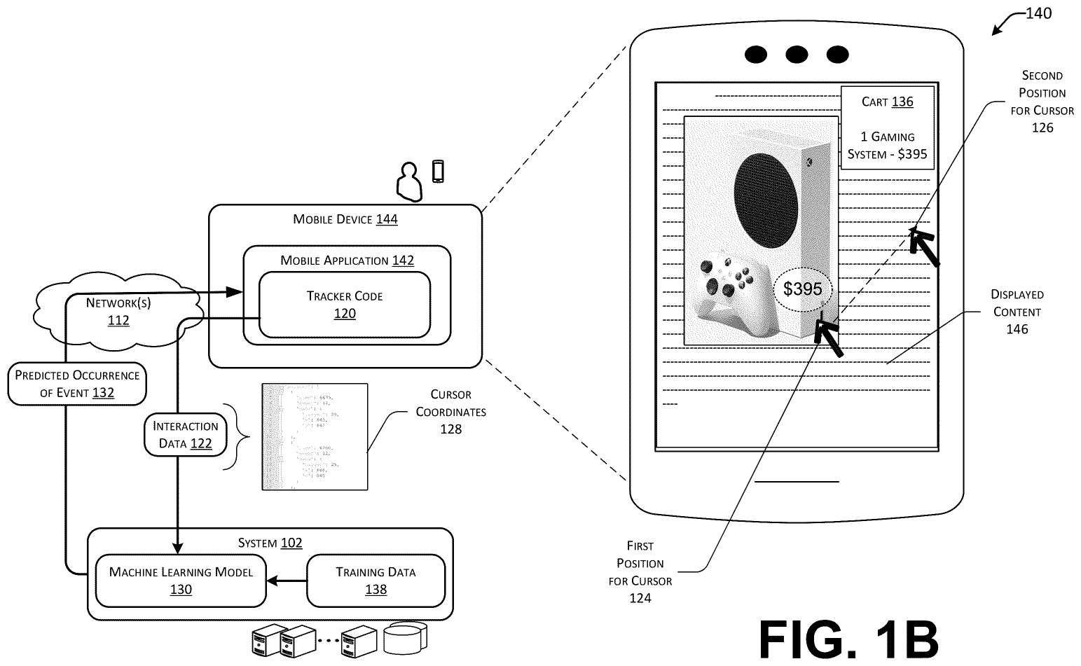

Various examples, scenarios, and aspects that effectively predict an occurrence of an event based on user interaction data associated with content of a webpage and/or a browser window in which the content of the webpage is displayed, and that provide the prediction of the occurrence of the event to a provider of the webpage are described below with reference to FIGS. 1-6.

FIG. 1A is a diagram illustrating an example environment 100 in which a system 102 is configured to predict an occurrence of an event based on interaction data associated with a webpage. The system 102 provides the prediction of the occurrence of the event to a provider of the webpage. FIG. 1A illustrates a computing device 104 executing a browser 106 configured to access and download webpage code 108 from a content provider 110 via various network(s) 112. The webpage code 108 is configured to render a webpage 114 (e.g., “www.shoppingspot.com/gamesystem”) for display via a browser window 116 displayed on a screen connected to the computing device 104.

In various examples, device(s) of the system 102 can include one or more computing devices that operate in a cluster or other grouped configuration to share resources, balance load, increase performance, provide fail-over support or redundancy, or for other purposes. For instance, device(s) of the system 102 can be server-type devices.

The computing device 104 can include, but is not limited to, a desktop computing device, a tablet computing device, a laptop computing device, a smartphone computing device, a wearable computing device, or any other sort of computing device capable of downloading and displaying content from webpages. To this end, the computing device 104 can include input/output (I/O) interfaces that enable communications with input/output devices such as user input devices including peripheral input devices (e.g., a keyboard, a mouse, a pen, a voice input device, a touch input device, a gestural input device, and the like) and/or output devices including peripheral output devices (e.g., a display, a printer, audio speakers, a haptic output device, and the like). The computing device 104 can also include network interface(s) to enable communications between device(s) over network(s) 112. Such network interface(s) can include a network interface controller (NIC) or other types of transceiver devices to send and receive communications and/or data over network(s) 112.

Network(s) 112 can include, for example, public networks such as the Internet, private networks such as an institutional and/or personal intranet, or some combination of private and public networks. Network(s) 112 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, 5G, and so forth) or any combination thereof. Network(s) 112 can utilize communications protocols, including packet-based and/or datagram-based protocols such as internet protocol (IP), transmission control protocol (TCP), user datagram protocol (UDP), or other types of protocols. Moreover, network(s) 112 can also include a number of devices that facilitate network communications and/or form a hardware basis for the networks, such as switches, routers, gateways, access points, firewalls, base stations, repeaters, backbone devices, and the like.

The content provider 110 is typically a developer and/or an operator of a website 118 or web application (e.g., an ecommerce website) that includes the webpage 114. As shown, the webpage 114 includes tracker code 120 (e.g., a script). The system 102 provides the tracker code 120 to the content provider 110 so that the tracker code 120 is downloaded and executed via the browser 106 of the computing device 102 along with the webpage code 108.

The tracker code 120 is configured to track and provide interaction data 122, associated with the webpage 114, to the system 102. The interaction data 122 includes, or represents, user interactions with content of the webpage 114 and/or with the browser window 116 within which the content of the webpage 114 is rendered for display. The content of the webpage 114 can include various graphical user interface elements for title text, body text, images, drawings, and so forth. A graphical user interface element can be selectable (e.g., a clickable button) or not selectable. The browser window 116 can include an address bar, a tab for the webpage 114, and/or functionality related to interacting with the webpage (e.g., scrolling controls, an exit button to close the webpage, a refresh button to reload the webpage, a button to add the webpage to a favorites list).

As shown in the example of FIG. 1, the webpage 114 displays a gaming system being offered for sale for $395. In the example of FIG. 1, an individual user interaction includes movement of a cursor (e.g., under control of a mouse or touch) from a first position 124 on the webpage and/or the browser window to a second position 126 on the webpage 114 and/or the browser window 116. Accordingly, the interaction data 122 includes coordinates 128 (e.g., x/y coordinates) that represent positions of the cursor as the cursor moves about the display screen. An individual user interaction can additionally or alternatively include a scrolling action that changes the content of the webpage 114 that is currently rendered in the browser window 116. Accordingly, the interaction data 122 can identify portions of the webpage 114 that are visible to a user at a given time and/or how often a user is scrolling to view new portions of the webpage 114. An individual user interaction can additionally or alternatively include input (e.g., a selection, a hover over) related to graphical user interface elements rendered via the webpage 114. Accordingly, the interaction data 122 can include an identification of the graphical user interface element associated with the input.

Moving on, the system 102 receives the interaction data 122 from the tracker code 120 executing via the browser 106. The system 102 then applies a machine learning model 130 to the interaction data 122 (e.g., uses the interaction data 122, or information generated based on it, as input for the machine learning model 130). The machine learning model 130 is configured to predict an occurrence of an event 132 and provide the predicted occurrence of the event 132 to the content provider 110 in real-time, or near real-time. As described above, the timing with which the predicted occurrence of the event 132 is provided presents the content provider 110 with an opportunity to immediately act, or respond to the predicted occurrence of the event 132, before a user actually implements the occurrence of the event.

The manner in which the webpage 114 and/or the website 118 renders content for display and interaction contributes to the user experience offered by the webpage 114 and/or the website 118. Furthermore, the content provider 110 may define strategic goals for the webpage 112 and/or the website 118 that are achieved based on actions the user takes. In the context of ecommerce, example goals can include getting a user to complete a purchase of a product found on the website. Consequently, the events that are predicted and reported to the content provider 110, by the system 102, are typically related to the state of the user experience. Stated alternatively, the state of the user experience can represent a quality in which webpage content is rendered for display and interaction. Moreover, the state of the user experience can represent whether user interactions align with strategic goals established for the webpage by the provider of the webpage.

FIG. 1A illustrates that the content provider 110 monitors the different user experience(s) 134 (e.g., different users interacting with the webpage) to ensure that a standard of quality is present and/or to ensure that internal goals are being met. The tracker code 120 is useable by the content provider 110 to ensure that meaningful information (e.g., predictions of meaningful events) that represents, or provides insight into, the state of the user experience can be reported in a timely manner.

The machine learning model 130 is configured and/or trained, as will be described in greater detail below, to predict occurrence for different types of events that are meaningful to providers of webpages. For example, some events can indicate, to a provider of a webpage, that a user is frustrated with the manner in which the webpage renders its content for display and interaction (e.g., the layout makes it difficult to find a particular graphical user interface element), and thus, the user is about to leave the webpage. In another example, some events can indicate, to a provider of a webpage, that a user is about to implement an action that has a negative effect on strategic goals defined for the webpage. In yet another example, some events can indicate, to a provider of a webpage, that a user is pleased with the manner in which the webpage renders its content for display and interaction. Accordingly, a prediction of an occurrence of an event by the machine learning model can provide meaningful information about the quality of the experience for a particular user.

The meaningful information can be positive such that the quality of the experience is meeting expectations for the user and/or for the provider of the webpage. For example, a specific type of event can signal that an ecommerce item is predicted to be added to the online shopping cart (e.g., an “Add to Cart” event) and/or predicted to be purchased (e.g., a “Purchase Detection” event). These types of events are generally a positive event for an ecommerce webpage. Accordingly, the provider of the ecommerce webpage may act on the predicted occurrence of these events to recommend additional ecommerce items for the user to add to the online shopping cart (e.g., upsell the currently added item to a higher quality version, introduce a new item related to the one already added to the online shopping cart).

In another example, a specific type of event can signal that an article presented for consumption on a webpage is predicted to be fully consumed (e.g., an “Article Fully Consumed” event). This type of event is also generally a positive event for an article webpage. Accordingly, the provider of the article webpage may act on the predicted occurrence of this event to fetch and present a link to another related article before the user leaves the webpage and/or the website.

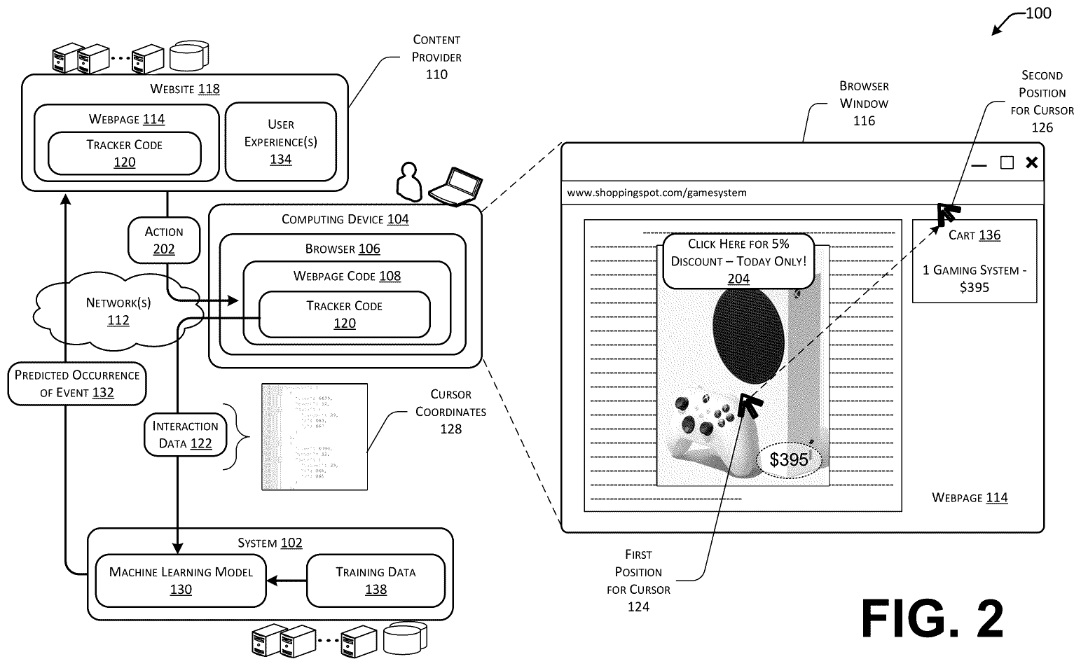

In contrast, the meaningful information can be negative such that the quality of the experience is not meeting expectations for the user and/or for the provider of the webpage. For example and as shown in FIG. 1A as the cursor is moving toward the close webpage function (e.g., the X in the corner of the browser window 116), a specific type of event can signal that an online shopping cart 136 that already contains an item (e.g., the gaming system for $395) is going to be abandoned (e.g., a “Cart Abandoned” event). This type of event is generally a negative event for an ecommerce webpage. Accordingly, as shown in FIG. 2, the content provider 110 may immediately implement an action 202, via the webpage code 108, in response to the predicted occurrence of this event “Cart Abandoned” 132. In this example, the action 202 displays a pop-up graphical user interface element 204 that offers a 5% discount for the gaming system in the online shopping cart 136 in case the (high) price of the gaming system is the reason the user appears to be abandoning the online shopping cart 136.

In another example, a type of event can signal that a user needs help with a particular function offered by the webpage (e.g., a “User Frustrated” event). This type of event is also generally a negative event for any type of webpage. Accordingly, the provider of the webpage may act on the predicted occurrence of this event by introducing, moving, and/or increasing the size of a support button for the function so the user can easily notice and select the support button.

The aforementioned examples are just a few of many different types of events that can provide meaningful insights to providers of different types of webpages and websites. Consequently, the providers of the webpages are equipped with actionable information useable to improve the user experience. In various examples, a provider of a webpage can provide input that defines a type of event that is meaningful, as this may vary from one provider to the next.

Turning the attention back to FIG. 1, the system 102 trains the machine learning model 130 to predict occurrences of events using training data 138. The training data 138 includes labeled interaction data 138 that is known to precede an occurrence of the event (e.g., the label indicates that the event actually occurred). The training data 138 can include billions or even trillions of unstructured user interactions.

FIG. 1B illustrates an example environment 140 in which the system 102 is configured to predict an occurrence of an event 132 based on interaction data 122 associated with an application 142 executing on a mobile device 144, and to provide the prediction of the occurrence of the event 132 to the application 144. Some of the aspects in the example environment 140 of FIG. 1B are the same or similar to those illustrated in and/or discussed with regard to FIG. 1A. However, in the example environment 140 of FIG. 1B, there is neither a webpage 118 nor a website 118. Instead, a user must install the application 142 on the mobile device 144 and the mobile device 144 executes the application 142 such that content of the application is displayed via the application 142 (and not the browser 106).

In this example, the tracker code 120 (e.g., a mobile software development kit (SDK)) is bundled with the application 142, and the interaction data 122 captures user interactions that are native to the application 142. Moreover, the displayed content 146 is now based on a layout graph for the application 142. In various examples, the mobile device 144 executes a hybrid application where part of the user experience is provided via the native application 142 and part of the user experience is provided via a web view control running inside the native application 142.

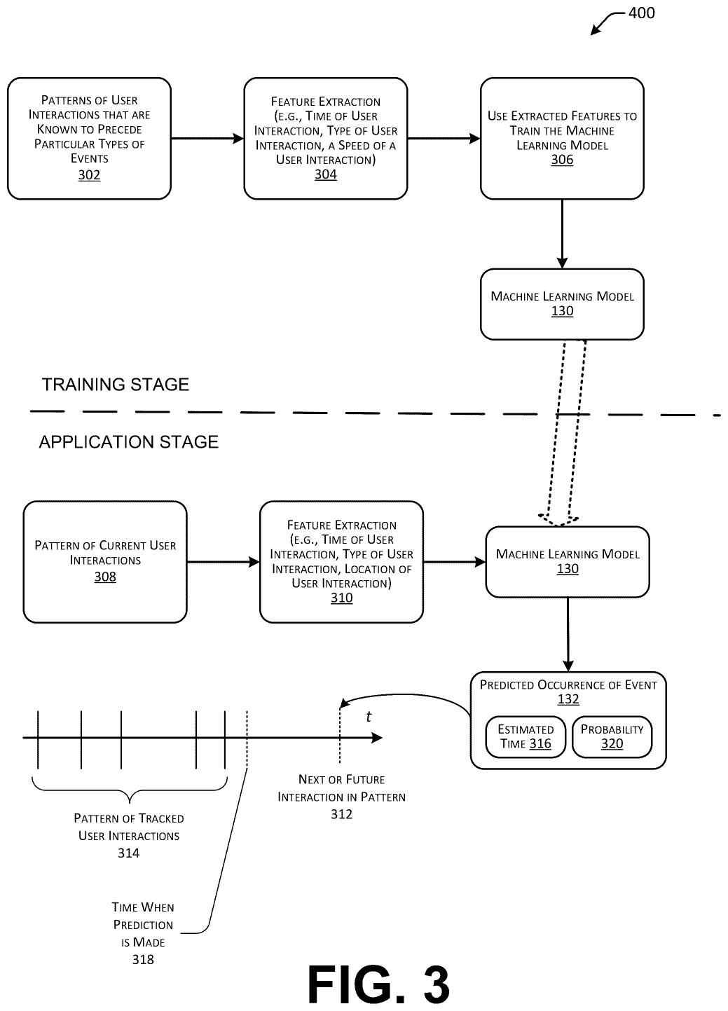

FIG. 3 illustrates a diagram that captures a training stage and an application stage for a machine learning model such as the machine learning model 130 of FIGS. 1 and 2. The machine learning model 130 can be any type of predictive model that can be applied to features extracted from unstructured interaction data. Accordingly, the machine learning model 130 can use any one of neural networks (e.g., convolutional neural networks, recurrent neural networks such as Long Short-Term TRansformer, etc.), Naïve Bayes, k-nearest neighbor algorithm, majority classifier, support vector machines, random forests, boosted trees, Classification and Regression Trees (CART), and so on.

During the training stage, the machine learning model 130 can be trained by the system 102 using a training data set 302. The training data set 302 includes patterns of user interactions (e.g., cursor movement(s), scrolling behavior(s), graphical user interface element selection(s)) that are known to precede particular types of events (e.g., “Add to Cart”, “Purchase Detection”, “Article Fully Consumed”, “Abandoned Cart”, “User Frustrated”). The system 102 performs feature extraction 304 on the training data 302 and uses the extracted features to train 306 the machine learning model 130.

In various examples, the features extracted from the patterns can include the timing associated with a user interaction, a type of user interaction (e.g., cursor movement, a scroll, a selection of a graphical user interface element based on the content of the webpage or the application), a speed at which a user interaction occurs (e.g., fast, erratic scrolling provides a different signal compared to methodical, controlled scrolling), and so forth.

After the training stage is complete, the machine learning model 130 can be used in the application stage to predict an occurrence of an event. That is, a pattern of current user interactions 308 tracked and collected by the tracker code 120 for a user engagement session with a webpage or an application is provided. The system 102 implements feature extraction 310 on the pattern of current user interactions 308 and applies the machine learning model 130 to the extracted features. The machine learning model 130 predicts an occurrence of an event 132 based on the extracted features.

As shown in the time t axis of FIG. 3, the predicted occurrence of the event 132 may correspond to a future user interaction (e.g., a next user interaction) 312 in an identified pattern of tracked user interactions 314 that has already occurred (as captured via the tracker code 120).

The machine learning model 130 can be configured to determine an estimated time 316 at which the event 132 is predicted to occur. The estimated time 316 can be provided to the content provider 110 or the application 142 along with the prediction of the occurrence of the event 132. In this way, the content provider 110 or the application 142 is made aware of the likely amount of time before the predicted event occurs.

In various examples, the system 102 can determine that the amount of time between a time when the future user interaction is predicted 318 by the machine learning model 130 and the estimated time 316 is greater than a threshold amount of time, and thus, satisfies a constraint placed on communicating the predicted occurrence of the event 132. That is, the threshold amount of time can be established to ensure the content provider has a sufficient amount of time to respond to the prediction in a meaningful and beneficial manner (e.g., respond to the prediction in near real-time). Moreover, the threshold amount of time can be established for a specific type of event. The prediction of the occurrence of the event can be provided in response to determining that the amount of time between the time when the prediction is made by the machine learning model and the estimated time 316 is greater than the threshold amount of time.

Furthermore, the machine learning model 130 can be configured to determine a probability 320 that the event will occur. The probability 320 can be used by the system 102 to determine a confidence level associated with the prediction of the occurrence of the event 132, and more importantly, to determine whether the prediction of the occurrence of the event 132 should be provided to the content provider 110 or the application 142. For example, the system 102 can compare the probability 320 to a probability threshold (e.g., 80%). If the probability 320 (e.g., 90%) is greater than the probability threshold (e.g., 90%>80%), then the prediction of the occurrence of the event 132 is provided to the content provider 110 or the application 142. In contrast, if the probability 320 (e.g., 70%) is less than or equal to the probability threshold (e.g., 70%≤80%), then the prediction of the occurrence of the event 132 is not provided to the content provider 110 or the application 142. The probability threshold described above can be established to control the number of predictions provided to the content provider 110 or the application 142 (e.g., limit the reported predictions to confident ones). Moreover, the probability threshold can be established based on a type of event (e.g., specific probability thresholds can be established for specific types of events) and/or based on input from the content provider 110 or the application 142 (e.g., one content provider may want a higher probability threshold while another content provider may want a lower probability threshold).

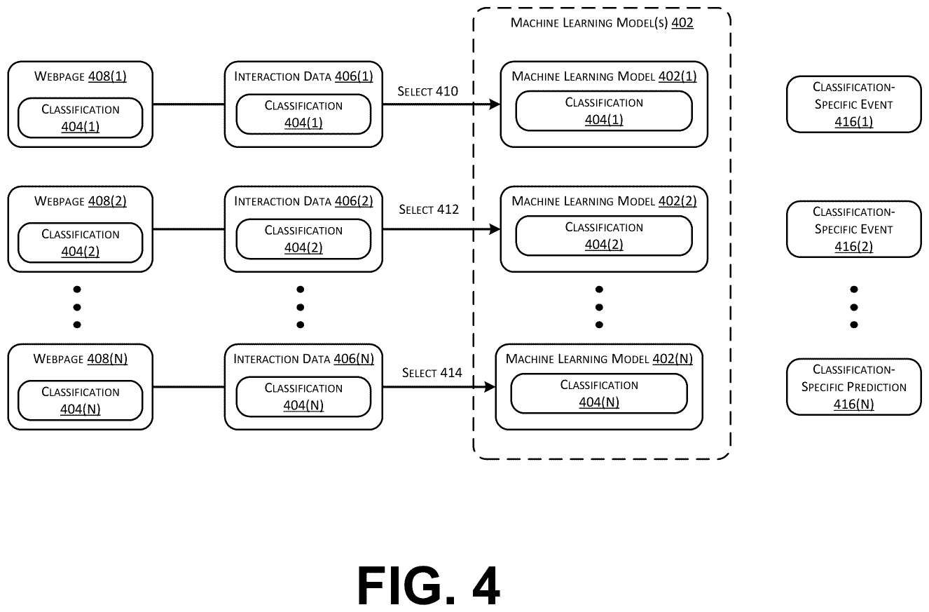

FIG. 4 illustrates a diagram that captures how different machine learning models can be trained to predict events for different types of webpages. In this example, the system 102 can train and use multiple machine learning models 402(1-N) based on different classifications 404(1-N), or types, of webpages or applications. The reason for training and using multiple machine learning models 402(1-N) is because the same or similar pattern of user interactions may lead to, or predict, different types of events across different classifications 404(1-N) of webpages. For example, a pattern of user interactions can be analyzed for an ecommerce webpage to predict an event related to a cart, while the same or similar pattern of user interactions can be analyzed for an article webpage to predict that an article has been fully consumed.

Accordingly, the training data 302 in FIG. 3 can be sorted according to the different classifications 404(1-N) so that the different machine learning models 402(1-N) can be generated. Turning back to FIG. 4, when first interaction data 406(1) is received for a first webpage 408(1) associated with the first classification 404(1), the classification 404(1) label is used to select 410 the suitable machine learning model 402(1) for analysis. Similarly, when second interaction data 406(2) is received for a second webpage 408(2) associated with the second classification 404(2), the classification 404(2) label is used to select 412 the suitable machine learning model 402(2) for analysis. And when n^{th} interaction data 406(N) is received for an n^{th} webpage 408(N) associated with the n^{th} classification 404(N), the classification 404(N) label is used to select 414 the suitable machine learning model 402(N) for analysis. Based on the mappings and selections, each of the machine learning models 402(1-N) can predict a classification-specific event 416(1-N).

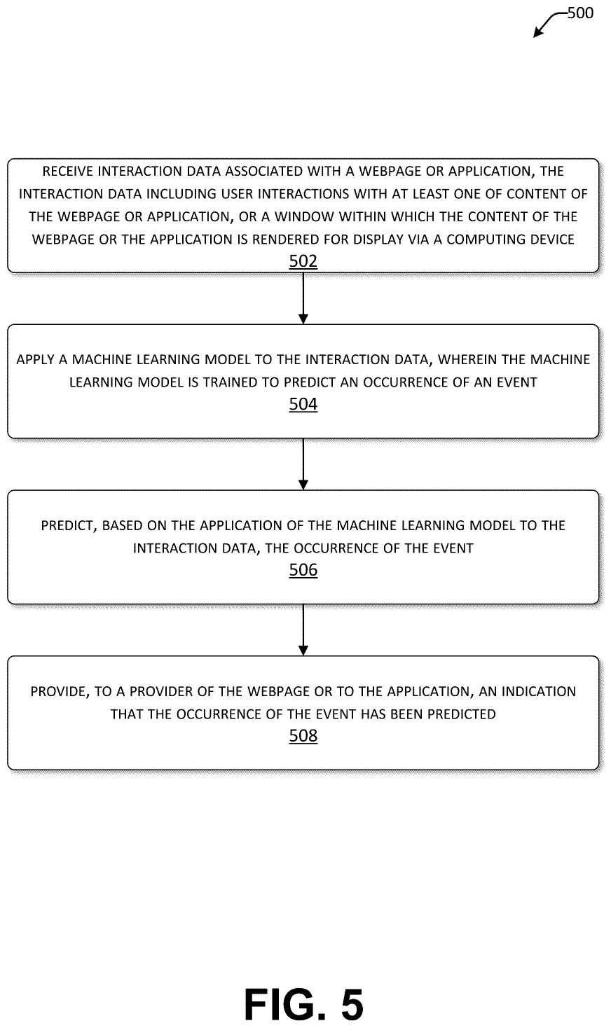

FIG. 5 represents an example process in accordance with various examples from the description of FIGS. 1-4. The example operations shown in FIG. 5 can be implemented on or otherwise embodied in one or more device(s) of the system 102.

The order in which the operations are described is not intended to be construed as a limitation, and any number of the described operations can be combined in any order and/or in parallel to implement each process. Moreover, the operations in FIG. 5 can be implemented in hardware, software, and/or a combination thereof. In the context of software, the operations represent computer-executable instructions that, when executed by one or more processing units, cause one or more processing units to perform the recited operations. For example, modules and other components described herein can be stored in a computer-readable storage media and executed by at least one processing unit to perform the described operations.

FIG. 5 is a flow diagram of an example method 500 for predicting an occurrence of an event based on interaction data associated with a webpage.

At operation 502, interaction data associated with a webpage or an application is received. As described above, the interaction data includes user interactions with at least one of content of the webpage or the application, or a window within which the content of the webpage or the application is rendered for display via a computing device.

At operation 504, a machine learning model is applied to the interaction data. The machine learning model is trained to predict an occurrence of an event.

At operation 506, the occurrence of the event is predicted based on the application of the machine learning model to the interaction data.

At operation 508, an indication that the occurrence of the event has been predicted is provided to a provider of the webpage or to the application.

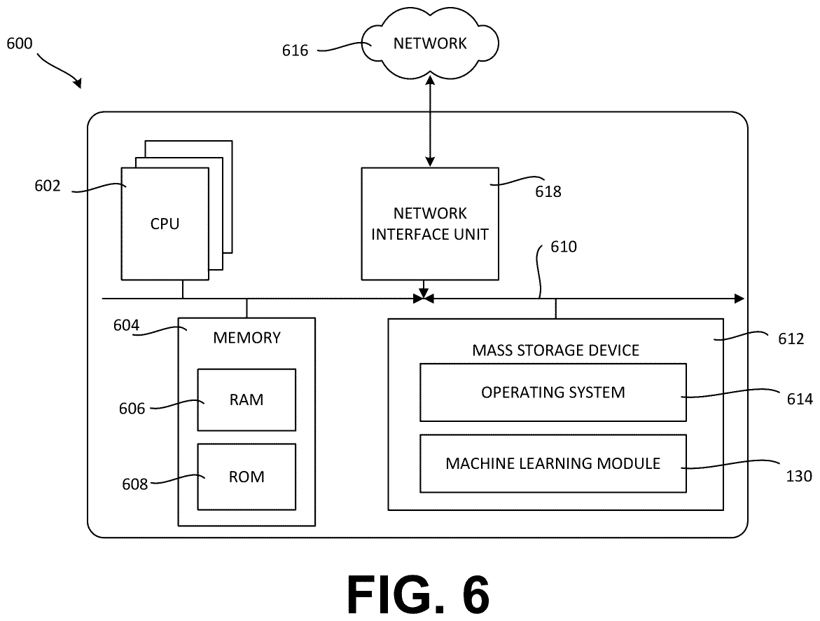

FIG. 6 is a computer architecture diagram showing an illustrative computer hardware and software architecture for a computing device that can implement the various technologies presented herein. In particular, the architecture illustrated in FIG. 6 can be utilized to implement a server or other type of computing device capable of implementing the system 102 in FIG. 1.

The computing device 600 illustrated in FIG. 6 includes a central processing unit 602 (“CPU”), a system memory 604, including a random-access memory 606 (“RAM”) and a read-only memory (“ROM”) 608, and a system bus 610 that couples the memory 604 to the CPU 602. A basic input/output system (“BIOS” or “firmware”) containing the basic routines that help to transfer information between elements within the computing device 600, such as during startup, can be stored in the ROM 608. The computing device 600 further includes a mass storage device 612 for storing an operating system 614, application programs, and/or other types of programs. The mass storage device 612 can also be configured to store other types of programs and data, such as the machine learning model 130.

The mass storage device 612 is connected to the CPU 602 through a mass storage controller connected to the bus 610. The mass storage device 612 and its associated computer readable media provide non-volatile storage for the computing device 600. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computing device 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computing device 600. For purposes of the claims, the phrase “computer storage medium,” and variations thereof, does not include waves or signals per se or communication media.

According to various configurations, the computing device 600 can operate in a networked environment using logical connections to remote computers through a network such as the network 616. The computing device 600 can connect to the network 616 through a network interface unit 618 connected to the bus 610. It should be appreciated that the network interface unit 618 can also be utilized to connect to other types of networks and remote computer systems.

It should be appreciated that the software components described herein, when loaded into the CPU 602 and executed, can transform the CPU 602 and the overall computing device 600 from a general-purpose computing device into a special-purpose computing device customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein. These computer-executable instructions can transform the CPU 602 by specifying how the CPU 602 transitions between states, thereby transforming the transistors or other discrete hardware elements constituting the CPU 602.

The disclosure presented herein also encompasses the subject matter set forth in the following clauses.

Example Clause A, a method comprising: receiving interaction data associated with a webpage, the interaction data including user interactions with at least one of content of the webpage or a browser window within which the content of the webpage is rendered for display via a computing device; applying, by a processing unit, a machine learning model to the interaction data, wherein the machine learning model is trained to predict an occurrence of an event; predicting, based on the application of the machine learning model to the interaction data, the occurrence of the event; and providing, to a provider of the webpage, an indication that the occurrence of the event has been predicted.

Example Clause B, the method of Example Clause A, further comprising training the machine learning model to predict occurrences of the event using training data including user interactions that are known to precede the event.

Example Clause C, the method of Example Clause B, further comprising receiving, from the provider of the webpage, input that defines the event, wherein the machine learning model is trained to predict the occurrences of the event based on the input that defines the event.

Example Clause D, the method of any one of Example Clauses A through C, wherein: the webpage is associated with a classification based on a service offered by the webpage; the machine learning model is trained to predict the occurrence of the event for the classification associated with the webpage; and the method further comprises selecting the machine learning model, from a plurality of machine learning models, based on the classification associated with the webpage.

Example Clause E, the method of any one of Example Clauses A through D, wherein the event that represents a user experience offered by the webpage.

Example Clause F, the method of any one of Example Clauses A through E, wherein: the interaction data includes a pattern of user interactions; and the occurrence of the event is predicted by the machine learning model to be a future user interaction in the pattern of user interactions.

Example Clause G, the method of Example Clause F, further comprising: determining, by the machine learning model, a probability that the future user interaction in the pattern of user interactions is to occur; and determining that the probability is greater than a threshold probability, wherein the indication that the occurrence of the event has been predicted is provided in response to determining that the probability is greater than the threshold probability.

Example Clause H, the method of Example Clause For Example Clause G, further comprising determining, by the machine learning model, an estimated time for the future user interaction, wherein the indication that the occurrence of the event has been predicted includes the estimated time for the future user interaction.

Example Clause I, the method of Example Clause H, further comprising determining that an amount of time between a time when the future user interaction is predicted by the machine learning model and the estimated time satisfies a constraint, wherein the indication that the occurrence of the event has been predicted is provided in response to determining that the amount of time between the time when the future user interaction is predicted by the machine learning model and the estimated time satisfies the constraint.

Example Clause J, the method of any one of Example Clauses A through I, wherein: an individual user interaction comprises movement of a cursor from a first position on the webpage to a second position on the webpage or the browser window and the interaction data includes coordinates that represent the movement of the cursor; an individual user interaction comprises scrolling through the webpage and the interaction data identifies currently displayed portions of the webpage that are viewable based on the scrolling; or an individual user interaction comprises input associated with a graphical user interface element rendered via the webpage and the interaction data includes an identification of the graphical user interface associated with the input.

Example Clause K, a system comprising: a processing unit; and a computer-readable storage medium having computer-executable instructions stored thereupon, which, when executed by the processing unit, cause the processing unit to perform operations comprising: receiving interaction data associated with a webpage, the interaction data including user interactions with at least one of content of the webpage or a browser window within which the content of the webpage is rendered for display via a computing device; applying a machine learning model to the interaction data, wherein the machine learning model is trained to predict an occurrence of an event; predicting, based on the application of the machine learning model to the interaction data, the occurrence of the event; and providing, to a provider of the webpage, an indication that the occurrence of the event has been predicted.

Example Clause L, the system of Example Clause K, wherein the operations further comprise training the machine learning model to predict occurrences of the event using training data including user interactions that are known to precede the event.

Example Clause M, the system of Example Clause K or Example Clause L, wherein: the webpage is associated with a classification based on a service offered by the webpage; the machine learning model is trained to predict the occurrence of the event for the classification associated with the webpage; and the operations further comprise selecting the machine learning model, from a plurality of machine learning models, based on the classification associated with the webpage.

Example Clause N, the system of any one of Example Clauses K through M, wherein: the interaction data includes a pattern of user interactions; and the occurrence of the event is predicted by the machine learning model to be a future user interaction in the pattern of user interactions.

Example Clause O, the system of Example Clause N, wherein the operations further comprise: determining, by the machine learning model, a probability that the future user interaction in the pattern of user interactions is to occur; and determining that the probability is greater than a threshold probability, wherein the indication that the occurrence of the event has been predicted is provided in response to determining that the probability is greater than the threshold probability.

Example Clause P, a method comprising: receiving interaction data associated with an application, the interaction data including user interactions with at least one of content of the application or a window within which the content of the application is rendered for display via a mobile device; applying, by a processing unit, a machine learning model to the interaction data, wherein the machine learning model is trained to predict an occurrence of an event; predicting, based on the application of the machine learning model to the interaction data, the occurrence of the event; and providing, to the application, an indication that the occurrence of the event has been predicted.

Example Clause Q, the method of Example Clause P, further comprising training the machine learning model to predict occurrences of the event using training data including user interactions that are known to precede the event.

Example Clause R, the method of Example Clause P or Example Clause Q, wherein: the application is associated with a classification based on a service offered by the application; the machine learning model is trained to predict the occurrence of the event for the classification associated with the application; and the method further comprises selecting the machine learning model, from a plurality of machine learning models, based on the classification associated with the application.

Example Clause S, the method of any one of Example Clauses P through R, wherein: the interaction data includes a pattern of user interactions; and the occurrence of the event is predicted by the machine learning model to be a future user interaction in the pattern of user interactions.

Example Clause T, the method of Example Clause S, further comprising: determining, by the machine learning model, a probability that the future user interaction in the pattern of user interactions is to occur; and determining that the probability is greater than a threshold probability, wherein the indication that the occurrence of the event has been predicted is provided in response to determining that the probability is greater than the threshold probability.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different events, two different predictions, etc.).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter. All examples are provided for illustrative purposes and is not to be construed as limiting.

1. A method comprising:
receiving interaction data associated with a webpage, the interaction data including user interactions with at least one of content of the webpage or a browser window within which the content of the webpage is rendered for display via a computing device;
applying, by a processing unit, a machine learning model to the interaction data, wherein the machine learning model is trained to predict an occurrence of an event;
predicting, based on the applying the machine learning model to the interaction data, the occurrence of the event; and
providing, to a provider of the webpage, an indication that the occurrence of the event has been predicted before the occurrence of the event.

2. The method of claim 1, further comprising training the machine learning model to predict occurrences of the event using training data including user interactions that are known to precede the event.

3. The method of claim 2, further comprising receiving, from the provider of the webpage, input that defines the event as a specific type of event, wherein the machine learning model is trained to predict the occurrences of the event as the specific type of event based on the input that defines the event.

4. The method of claim 1, wherein:
the webpage is associated with a classification based on a service offered by the webpage;
the machine learning model is trained to predict the occurrence of the event for the classification associated with the webpage; and
the method further comprises selecting the machine learning model, from a plurality of machine learning models, based on the classification associated with the webpage.

5. The method of claim 1, wherein the event represents a user experience offered by the webpage.

6. The method of claim 1, wherein:
the interaction data includes a pattern of user interactions; and
the occurrence of the event is predicted by the machine learning model to be a future user interaction in the pattern of user interactions.

7. The method of claim 6, further comprising:
determining, by the machine learning model, a probability that the future user interaction in the pattern of user interactions is to occur; and
determining that the probability is greater than a threshold probability, wherein the indication that the occurrence of the event has been predicted is provided before the occurrence of the event in response to determining that the probability is greater than the threshold probability.

8. The method of claim 6, further comprising determining, by the machine learning model, an estimated time for the future user interaction, wherein the indication that the occurrence of the event has been predicted includes the estimated time for the future user interaction.

9. The method of claim 8, further comprising determining that an amount of time between a time when the future user interaction is predicted by the machine learning model and the estimated time satisfies a constraint, wherein the indication that the occurrence of the event has been predicted is provided before the occurrence of the event in response to determining that the amount of time between the time when the future user interaction is predicted by the machine learning model and the estimated time satisfies the constraint.

10. The method of claim 1, wherein:
an individual user interaction comprises movement of a cursor from a first position on the webpage to a second position on the webpage or the browser window and the interaction data includes coordinates that represent the movement of the cursor;
an individual user interaction comprises scrolling through the webpage and the interaction data identifies currently displayed portions of the webpage that are viewable based on the scrolling; or
an individual user interaction comprises input associated with a graphical user interface element rendered via the webpage and the interaction data includes an identification of the graphical user interface associated with the input.

11. A system comprising:
a processing unit; and
a computer-readable storage medium having computer-executable instructions stored thereupon, which, when executed by the processing unit, cause the processing unit to perform operations comprising:
receiving interaction data associated with a webpage, the interaction data including user interactions with at least one of content of the webpage or a browser window within which the content of the webpage is rendered for display via a computing device;
applying a machine learning model to the interaction data, wherein the machine learning model is trained to predict an occurrence of an event;
predicting, based on the applying the machine learning model to the interaction data, the occurrence of the event; and
providing, to a provider of the webpage, an indication that the occurrence of the event has been predicted before the occurrence of the event.

12. The system of claim 11, wherein the operations further comprise training the machine learning model to predict occurrences of the event using training data including user interactions that are known to precede the event.

13. The system of claim 11, wherein:
the webpage is associated with a classification based on a service offered by the webpage;
the machine learning model is trained to predict the occurrence of the event for the classification associated with the webpage; and
the operations further comprise selecting the machine learning model, from a plurality of machine learning models, based on the classification associated with the webpage.

14. The system of claim 11, wherein:
the interaction data includes a pattern of user interactions; and
the occurrence of the event is predicted by the machine learning model to be a future user interaction in the pattern of user interactions.

15. The system of claim 14, wherein the operations further comprise:
determining, by the machine learning model, a probability that the future user interaction in the pattern of user interactions is to occur; and
determining that the probability is greater than a threshold probability, wherein the indication that the occurrence of the event has been predicted is provided before the occurrence of the event in response to determining that the probability is greater than the threshold probability.

16. A method comprising:
receiving interaction data associated with an application, the interaction data including user interactions with at least one of content of the application or a window within which the content of the application is rendered for display via a mobile device;
applying, by a processing unit, a machine learning model to the interaction data, wherein the machine learning model is trained to predict an occurrence of an event;
predicting, based on the applying the machine learning model to the interaction data, the occurrence of the event; and
providing, to the application, an indication that the occurrence of the event has been predicted before the occurrence of the event.

17. The method of claim 16, further comprising training the machine learning model to predict occurrences of the event using training data including user interactions that are known to precede the event.

18. The method of claim 16, wherein:
the application is associated with a classification based on a service offered by the application;
the machine learning model is trained to predict the occurrence of the event for the classification associated with the application; and
the method further comprises selecting the machine learning model, from a plurality of machine learning models, based on the classification associated with the application.

19. The method of claim 16, wherein:
the interaction data includes a pattern of user interactions; and
the occurrence of the event is predicted by the machine learning model to be a future user interaction in the pattern of user interactions.

20. The method of claim 19, further comprising:
determining, by the machine learning model, a probability that the future user interaction in the pattern of user interactions is to occur; and
determining that the probability is greater than a threshold probability, wherein the indication that the occurrence of the event has been predicted is provided before the occurrence of the event in response to determining that the probability is greater than the threshold probability.
